(19) United States
(12) Patent Application Publication
(10) Pub. No.: US 2014/0291013 A1
(43) Pub. Date: Oct. 2, 2014

(54) ELECTRICAL CONNECTION BOX

(71) Applicants: HONDA MOTOR CO., LTD, Tokyo (JP); SUMITOMO WIRING SYSTEMS, LTD., Yokkaichi (JP)

(72) Inventors: Eiji HIGUCHI, Yokkaichi (JP); Masayoshi NAKAMURA, Yokkaichi (JP); Masami SHIRAKI, Yokkaichi (JP); Yoshihiko GOTOU, Yokkaichi (JP); Yoshihiro ISSHIKI, Yokkaichi (JP); Takaaki FUKUI, Yokkaichi (JP); Koji IKUTA, Wako-shi (JP); Mikio SUINA, Wako-shi (JP)

(73) Assignees: HONDA MOTOR CO., LTD, Tokyo (JP); SUMITOMO WIRING SYSTEMS, LTD., Yokkaichi (JP)

(21) Appl. No.: 14/226,182

(22) Filed: Mar. 26, 2014

(30) Foreign Application Priority Data
Mar. 28, 2013 (JP) 2013-068739

(51) Int. Cl. B60R 16/02

(52) U.S. Cl. CPC B60R 16/02
USPC 174/535; 174/520

(57) ABSTRACT

According to one embodiment, an electrical connection box includes: a base unit including a common circuit to be used in common to multiple vehicle models or grades; multiple kinds of option units respectively including an addition circuit selectively usable according to vehicle models or grades and, wherein: the common circuit of the base unit and the addition circuit of one of the option units cooperate together to form an electric circuit to be connected to a load provided on a vehicle body by combining the one of the option units with the base unit; and the base unit and the one of the option unit are mounted on a case of synthetic resin prepared for every vehicle model or grade and are then fixed to the vehicle body.

### BACKGROUND

1. Field of the Invention

The invention relates to an electrical connection box to be mounted on vehicles such as automobiles.

2. Description of the Related Art

As known well, a vehicle such as an automobile mounts thereon a large number of electrical loads such as headlights, taillights, an engine starter and a wiper. To wire these loads efficiently, there is used an electrical connection box such as a relay box, a fuse box and a junction box.

Here, the conventional electrical connection boxes are individually designed and manufactured for the respective vehicle models because of the difference between the models or grades of vehicles (which is hereinafter called the difference of vehicle models), for example, the difference between the electric components of the respective vehicle models, the difference between the shapes of the arrangement spaces of the electrical connection boxes, or the difference between the mounting positions of the electrical connection boxes on the vehicle bodies. Thus, a new design is necessary whenever a vehicle model is changed and thus the man-hour for development is required.

In view of the above, JP-A-H09-215154 proposes an electrical connection box which can cope with the difference of vehicle models by providing within a box main body a basic function circuit usable in common to multiple vehicle models and selectively incorporating in the box main body an addition function circuit required according to the difference of vehicle models. However, as described above, the specific shapes of the arrangement spaces of the electrical connection box differ according to the difference of vehicle models. Therefore, in the electrical connection box of JP-A-H09-215154, whenever its mounting position onto a vehicle body changes, the box main body, together with the basic function circuit included therein, must be designed again, which makes it difficult to flexibly cope with the difference of vehicle models.

Also, JP-A-2000-253541 proposes an electrical connection box in which an exclusive circuit required exclusively for each vehicle model is arranged in its box main body and a standard circuit usable in common is removably provided in the box main body. Here, for example, a power window and a keyless control are not always mounted in all vehicle models and thus they must be constituted of an exclusive circuit. However, recently, they are often mounted even in a vehicle model of a relatively low grade and thus they are used in common in multiple vehicle grades. Therefore, in the case that an exclusive circuit is provided in the box main body, when designing a box main body according to the respective vehicle grades, an exclusive circuit to be employed in common to multiple vehicle grades is designed overlappingly, thereby inherently raising a problem that the man-hour can vary. Also, similarly to JP-A-H09-215154, when the mounting position onto the vehicle body varies, the box main body must be redesigned together with the exclusive circuit.

### SUMMARY

This invention is made in view of the above prior-art circumstances and thus it is an object of the invention to provide an electrical connection box having a new structure which can flexibly cope with the difference of vehicle models or grades and can reduce the man-hour for development and its manufacturing cost.

According to a first aspect of the invention, there is provided an electrical connection box including: a base unit including a common circuit to be used in common to multiple vehicle models or grades; multiple kinds of option units respectively including an addition circuit selectively usable according to vehicle models or grades and, wherein: the common circuit of the base unit and the addition circuit of one of the option units cooperate together to form an electric circuit to be connected to a load provided on a vehicle body by combining the one of the option units with the base unit; and the base unit and the one of the option unit are mounted on a case of synthetic resin prepared for every vehicle model or grade and are then fixed to the vehicle body.

In this aspect, a common circuit usable in common to multiple vehicle models is formed as a base unit. Thus, the base unit can be used in common to the multiple vehicle models. Further, addition circuits to be selectively used according to vehicle models or grades are formed such that they can be combined with the base unit as option units. Thus, addition circuits, which are not always mounted in all grades as standard equipment but are used in common to multiple grades, such as a keyless control circuit, can be used in common to multiple vehicle models as option units. As a result, when designing an electrical connection box for a new vehicle model, only the case may be designed newly and also, since the shapes of the base unit and option units are previously decided, the outline shape of the electrical connection box can be decided in an early stage, thereby being able to reduce the man-hour for development. Further, since only the case is a product to be newly developed, the capital investment for facilities can be reduced; and, since the base unit and option units can be diverted to the multiple vehicle models, the number of common use target vehicle models can be increased, which can reduce the manufacturing cost of the electrical connection box.

In addition, in the case of a new vehicle model, simply by changing the design of the case, the electrical connection box can be adapted to its mounting position on the new vehicle model. Especially, in this aspect, since the case is a resin molded product having no electric circuit, the shape of the case can be changed easily.

Still further, when the base unit and option units are formed once, in the new vehicle model development that is made thereafter, in the early production stage of a prototype during development, they can be used as actual-use products. Thus, in the evaluation test of the prototype, there can be eliminated the difference in material and specific shape between the prototype and an actually sold product, thereby being able to obtain test results near to the actually sold product.

Here, the number of cases for fixing the base unit and selected option unit to the vehicle body is not limited to one but, for example, the base unit and option unit may be mounted on separate cases and thus may be fixed to the different locations of the vehicle body.

According to a second aspect of the invention, in an electrical connection box according to the first aspect, the base unit includes a first electric part mounting portion, the one of the option units includes a second electric part mounting portion, and the synthetic resin is a material having lower heat resistance than the box bodies of the base unit and the option units.

Since the base unit and option units respectively include electric part mounting portions for mounting electric parts such as a fuse and a relay, in order to secure the dimension precision of the electric part mounting portions and also to cope with an increase in temperature, the units must be formed of a material having high heat resistance. On the other hand, since the case does not include electric part mounting portions or an electric circuit, as the case material, there can be employed a synthetic resin material which is low in heat resistance and inexpensive. As a result, the manufacturing cost of the case can be reduced. Also, employment of the low heat resistance material can reduce the specific gravity of the case and thus can reduce the weight of the electrical connection box.

In this invention, a common circuit for use in common to multiple vehicle models and grades is formed as a base unit, addition circuits selectively usable according to the vehicle models and grades are formed as option units, and the base unit and the required option unit are selectively mounted onto the case, thereby forming the electrical connection box. Thus, the base unit and option unit can be used in common to multiple vehicle models and grades and, simply by developing a case newly, the invention is able to cope with new vehicle model and grade. This can reduce the man-hour for development and capital investment for facilities, thereby being able to reduce the manufacturing cost of the electrical connection box.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is an exploded perspective view of an electrical connection box according to a first embodiment of the invention;

FIG. 2 is a plan view of a base unit;

FIG. 3 is a plan view of a relay block serving as an option unit;

FIG. 4 is a plan view of a fuse block serving as an option unit;

FIG. 5 is a plan view of a fusible link block serving as an option unit;

FIG. 6 is a plan view of a case with a base unit and an option unit mounted thereon;

FIG. 7 is a plan view, corresponding to FIG. 6, of an electrical connection box according to a second embodiment of the invention; and

FIG. 8 is a plan view, corresponding to FIG. 6, of an electrical connection box according to a third embodiment of the invention.

### DETAILED DESCRIPTION OF THE INVENTION

Description is given below of embodiments of the invention with reference to the accompanying drawings.

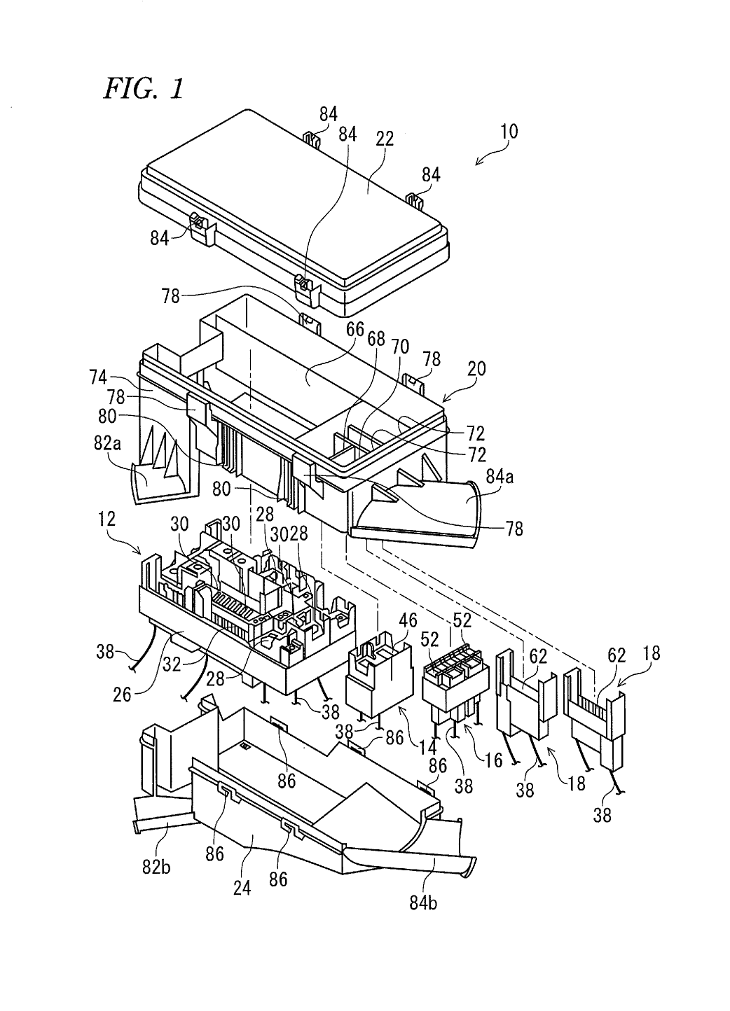

Firstly, FIG. 1 shows an electrical connection box 10 which is a first embodiment of the invention. The electrical connection box 10 includes a base unit 12, a relay block 14 serving as an option unit, a fuse block 16 serving as an option unit, an FL (fusible link) block 18 serving as an option unit, a case 20 for incorporating the above units therein, and an upper cover 22 and a lower cover 24 respectively to be mounted on the case 20. Here, in the following description, as the need arises, the relay block 14, fuse block 16 and FL block 18 are generally called option units 14˜18.

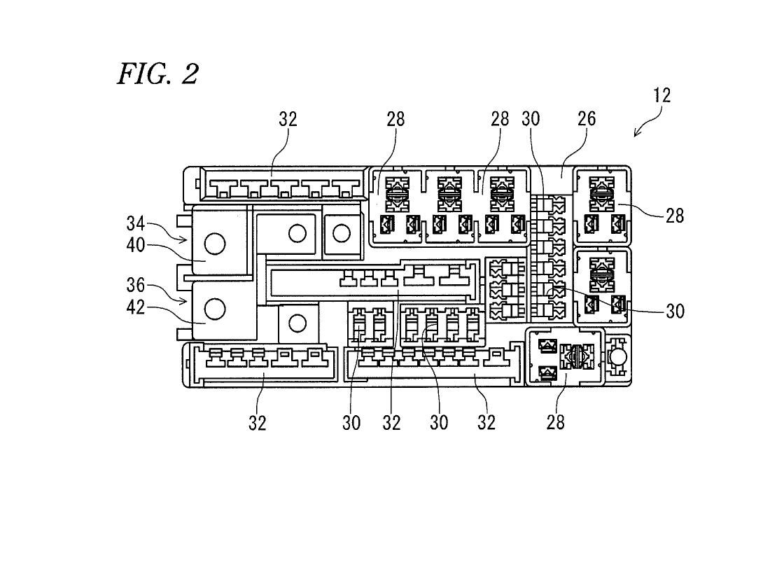

FIG. 2 shows the base unit 12. The base unit 12 includes a box body 26 made of synthetic resin and having a substantially rectangular block shape. The box body 26 includes, as electrical part mounting portions, an arbitrary number (including 0) of relay mounting portions 28, fuse mounting portions 30, fusible link mounting portions 32 and the like. Although not shown specifically, connection terminals are arranged in the relay mounting portions 28, fuse mounting portions 30 and fusible link mounting portions 32. The connection terminals may be formed individually, or multiple connection terminals may be formed integrally with bus bars 34, 36 and the like arranged within the box body 26, or they may be electric wires 38 respectively inserted into the mounting portions 28, 30 and 32 from below (from the lower cover 24 side).

On the relay mounting portions 28, fuse mounting portions 30 and fusible link mounting portions 32, there are mounted relays, fuses and fusible links serving as electric parts (not shown) respectively. The relays to be mounted on the relay mounting portions 28, fuses to be mounted on the fuse mounting portions 30 and fusible links to be mounted on the fusible link mounting portions 32 are used in common to multiple vehicle models and grades. For example, they are the parts that are electrically connected to loads such as headlights, taillights, an engine starter and a wiper. And, when the relays, fuses and fusible links are mounted on the relay mounting portions 28, fuse mounting portions 30 and fusible link mounting portions 32 and are connected to connection terminals (not shown) arranged within the respective mounting portions 28, 30 and 32, there is formed in the base unit 12 a common circuit which is used in common to multiple vehicle models or grades.

Also, input/output terminals 40 and 42 are formed integrally with the bus bars 34 and 36 arranged within the box body 26. The input/output terminals 40 and 42 are arranged such that they are exposed to the upper surface (upper cover 22 side) of the box body 26 in one of the end edges of the box body 26 in the longitudinal direction.

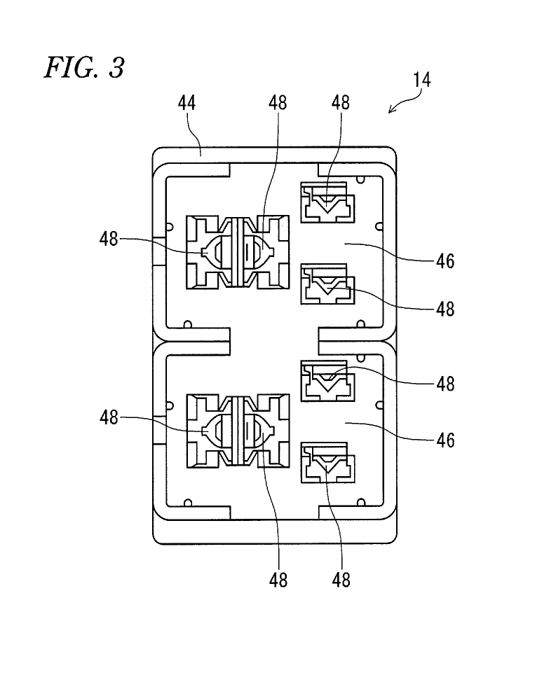

Next, FIG. 3 shows the relay block 14 enlargedly. The relay block 14 includes a box body 44 made of synthetic resin and having a substantially rectangular block shape. The box body 44 includes multiple (in this embodiment, two) relay mounting portions 46 serving as electric part mounting portions. Within the relay mounting portions 46, there are formed resin lances 48 with which connection terminals (not shown) of the electric wires 38 inserted from below (lower cover 24 side) can be engaged.

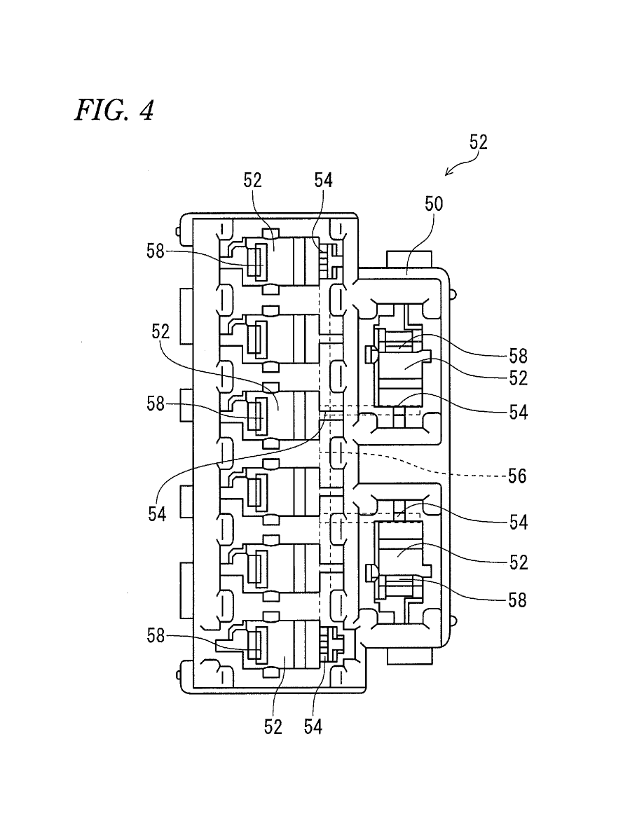

FIG. 4 shows the fuse block 16 enlargedly. The fuse block 16 includes a box body 50 made of synthetic resin and having a substantially rectangular block shape. The box body 50 includes multiple (in this embodiment, 8) fuse mounting portions 52 serving as electric part mounting portions. In one end of each fuse mounting portion 52, there is provided a connection terminal 54. In this embodiment, the connection terminals 54 provided in all fuse mounting portions 52 are formed integrally with a bus bar 56 arranged within the box body 50. Also, in the other end of each fuse mounting portion 52 disposed opposed to the connection terminal 54, there is provided a resin lance 58 with which the connection terminal (not shown) of the electric wire 38 inserted from below (the lower cover 24 side) is engaged, whereby the resin lance 58 is disposed opposed to the connection terminal 54 within each fuse mounting portion 52.

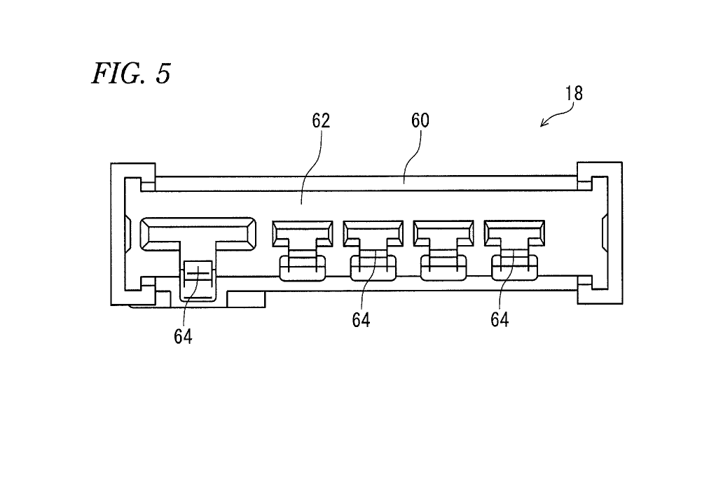

Next, FIG. 5 shows the FL block 18 enlargedly. The FL block 18 includes a box body 60 made of synthetic resin and having a substantially rectangular thin-plate-like shape. The box body 60 includes a fusible link mounting portion 62 serving as an electrical part mounting portion. Within the fusible link mounting portion 62, there are formed multiple resin lances 64 with which the connection terminals (not shown) of the electric wires 38 inserted from below (the lower cover 24 side) can be engaged respectively.

On the relay mounting portion 46 of the relay block 14, the fuse mounting portions 52 of the fuse block 16, and the fusible link mounting portions 62 of the FL block 18, there are mounted relays, fuses and fusible links serving as electric parts (not shown), respectively. The relays, fuses and fusible links mounted on the option units 14˜18 are used selectively according to vehicle models or grades. For example, they are electrically connected to loads such as a power window, a keyless control, fog lights, an audio apparatus and a theft prevention apparatus. When the relays, fuses and fusible links are connected to the option units 14˜18 respectively, in the respective option units 14˜18, there formed addition circuits which are used selectively according to vehicle models or grades.

As shown in FIG. 1, the base unit 12, relay block 14, fuse block 16 and FL block 18 are mounted on the case 20. The case 20 is an integrally molded part of synthetic resin. The specific shape of the case 20 is set in consideration of the shape of the arrangement space of the electrical connection box, the fixing position of the electrical connection box to a vehicle, and the specific shapes or the like of the base unit 12 and option units 14˜18 to be stored therein; the case 20 is prepared for every vehicle model or grade. The case 20 of this embodiment has a substantially rectangular box-like shape which is opened on both of the upper cover 22 side and lower cover 24 side. The interior of the case 20 is divided to multiple areas where a base unit storage portion 66 for storing the base unit 12, a relay block storage portion 68, a fuse block storage portion 70 and two FL block storage portions 72 are formed.

In the base unit storage portion 66, in the longitudinal-direction end portion of the case 20, there is formed a recess 76 which is produced when the peripheral wall 74 of the case 20 is recessed inwardly of the case 20 on the upper cover 22 side. Also, in the end portions of the peripheral wall 74 on the upper cover 22 side and lower cover 24 side, there are formed multiple lock portions 78, 80 at proper positions. Further, the case 20 includes electric wire take-out portions 82a, 84a respectively extending outward from the peripheral wall 74.

Thus, the case 20 is a box body which is formed only of synthetic resin and does not include electric part mounting portions such as a fuse mounting portion and a relay mounting portion or electric parts such as connection terminals and bus bars, or electric circuits. Here, although not shown, in the case 20, a mounting portion for fixing it to a vehicle body may be formed according to the shape of the vehicle body.

As a synthetic resin material for forming the box body 26 of the base unit 12 and the box bodies 44, 50 and 60 of the relay block 14, fuse block 16 and FL block 18 serving as option units, there is used a relatively high heat resistance material, for example, polyamide. On the other hand, as a synthetic resin material for forming the case 20, there can be used a material, for example, polypropylene which is lower in heat resistance than the box body 26 of the base unit 12 and the box bodies 44, 50 and 60 of the option units 14, 16 and 18.

To the above-structured case 20, there are assembled the upper cover 22 and lower cover 24. The upper cover 22 is an integrally molded part of synthetic resin and has a box-like shape opened on the case 20 side. The upper cover 22 includes lock portions 84 at positions corresponding to the lock portions 78 of the case 20. And, the lower cover 24 is an integrally molded part of synthetic resin and has a box-like shape opened on the case 20 side. The lower cover 24 includes lock portions 86 at positions corresponding to the lock portions 80 of the case 20. The lower 24 includes outwardly extending electric wire take-out portions 82b, 84b at positions corresponding to the electric wire take-out portions 82a, 84a of the case 20.

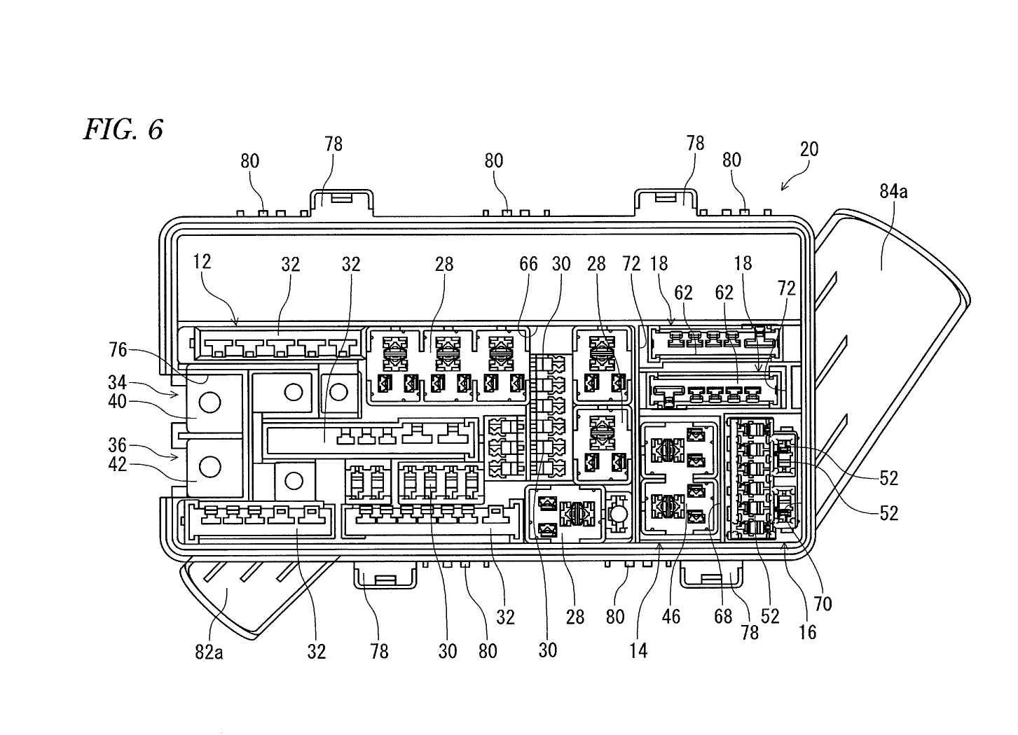

As shown in FIG. 1, the base unit 12, relay block 14, fuse block 16 and FL block 18 are respectively inserted into the base unit storage portion 66, relay block storage portion 68, fuse block storage portion 70 and FL block storage portion 72 of the case 20 from below (lower cover 24 side). Here, to the base unit 12 and option units 14˜18, there are connected relays, fuses, fusible links, electric wires 38 and the like serving as electric parts. However, they may be connected before or after they are assembled to the case 20. Also, the base unit 12, relay block 14, fuse block 16 and FL block 18 are respectively fixed to the case 20 by conventionally known locking means such as engagement between elastically deformable engaging pieces and engaging projections (not shown). Thus, as shown in FIG. 6, when the base unit 12 and option units 14˜18 are mounted on the case 20, the base unit 12 and option units 14˜18 form the electric circuit of the electrical connection box 10. Here, the input/output terminals 40, 42 provided on the base unit 12 are disposed below the recess 76 of the case 20 (on the lower cover 24 side) and are exposed to the outside of the case 20.

Next, the upper cover 22 is put on the case 20 and the lock portions 78 and lock portions 84 are engaged with each other, thereby assembling the upper cover 22 to the case 20. Also, the lower cover 24 is put on the case 20 from the opposite side of the upper cover 22 and the lock portions 80 and 86 are engaged with each other, thereby assembling the lower cover 24 to the case 20. Here, when the lower cover 24 is assembled, the electric wire take-out portions 82a and 82b and electric wire take-out portions 84a and 84b are put on each other, thereby forming a cylindrical-shaped electric wire take-out opening for taking out to the outside the electric wires 38 connected to the base unit 12 and option units 14˜18. Thus, the electrical connection box 10 is assembled. The electrical connection box 10 is fixed to a vehicle body through a mounting portion (not shown) formed in the case 20, while the base unit 12 and option units 14˜18 are fixed to the vehicle body through the case 20.

In the electrical connection box 10 having a structure according to this embodiment, a common circuit usable in multiple vehicle models is formed as the base unit 12 and also addition circuits usable selectively according to the vehicle model are formed as the option units 14˜18, while, as the need arises, one of them is selected and is combined with the base unit 12. Thus, the base unit 12 and option units 14˜18 can be used to multiple vehicle models. As a result, there can be eliminated the need to design again the whole of the electrical connection box whenever a new vehicle model is developed, thereby being able to reduce the man-hour for development.

Further, in order to allow the electrical connection box 10 to cope with a new vehicle model, a new case 20 may only be developed, which can reduce the man-hour for development and also investment for facilities. Especially, since the case 20 is a simple resin molded product having no electric part mounting portions or electric circuits, it is easy to change its design and the required dimension precision thereof can be lowered. Thus, the case 20 can be made of a material lower in heat resistance and cost than the base unit 12 and option units 14˜18, thereby being able to reduce the manufacturing cost thereof. Since use of the lower heat resistance material can lower the specific gravity of the case 20, the weight of the electrical connection box 10 can also be reduced.

Also, when the base unit 12 and option units 14˜18 are manufactured once, when developing a new vehicle model, in the early stage of a prototype, the same base unit 12 and option units 14˜18 as those provided in the actual market can be used. As a result, in the early stage of the prototype, in an evaluation test, test results near to the actual product can be obtained and thus the accuracy of the test can also be enhanced.

As described above, according to the invention, since one of the multiple option units is selected and is combined with a base unit, and the combined units are mounted onto a case, only by manufacturing a new case, an electrical connection box capable of coping with various vehicle models and grades can be provided. Description is given below of some embodiments of the invention different from the above embodiment. However, of course, the specific embodiments of the invention are not limited to the following embodiments. Also, in the following description, the composing elements and portions similar to the first embodiment are given the same designations as the first embodiment and thus the description thereof is omitted.

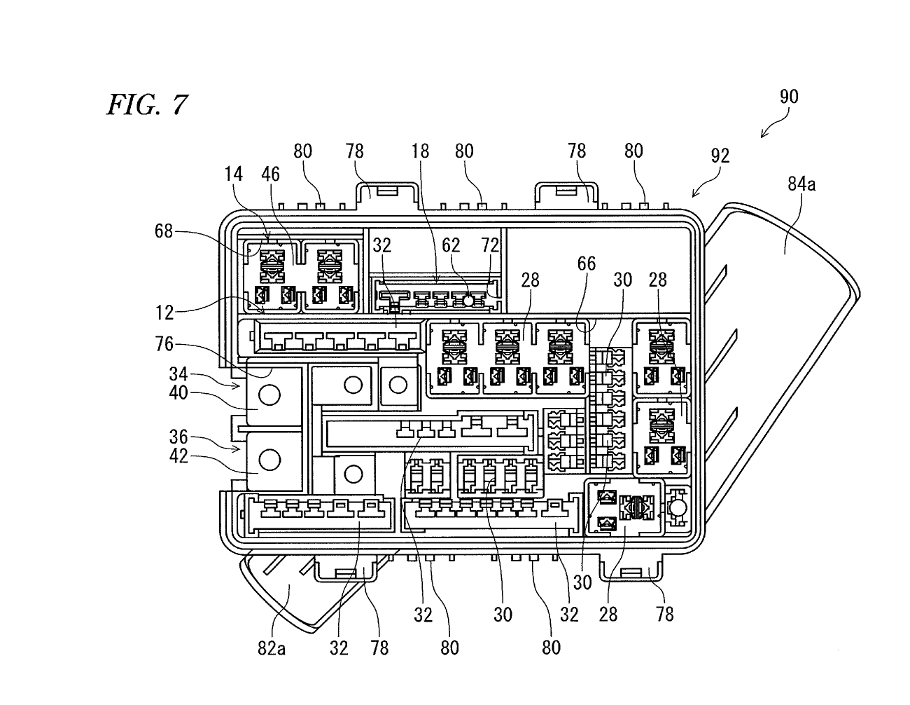

FIG. 7 shows an electrical connection box 90 as a second embodiment of the invention. In this embodiment, a base unit 12 and, as option units, a relay block 14 and an FL block 18 are selected and assembled into a case 92. The case 92 is smaller in size than the case 20 of the first embodiment and, in the case 92, a relay block storage portion 68 and an FL block storage portion 72 are formed adjacent to the short-side direction (in FIG. 7, vertical direction) of a base unit storage portion 66. In this manner, the case can be set in various shapes in consideration of the combination modes of the base unit and option unit(s) and the shapes of spaces for arrangement of the electrical connection box within a vehicle body.

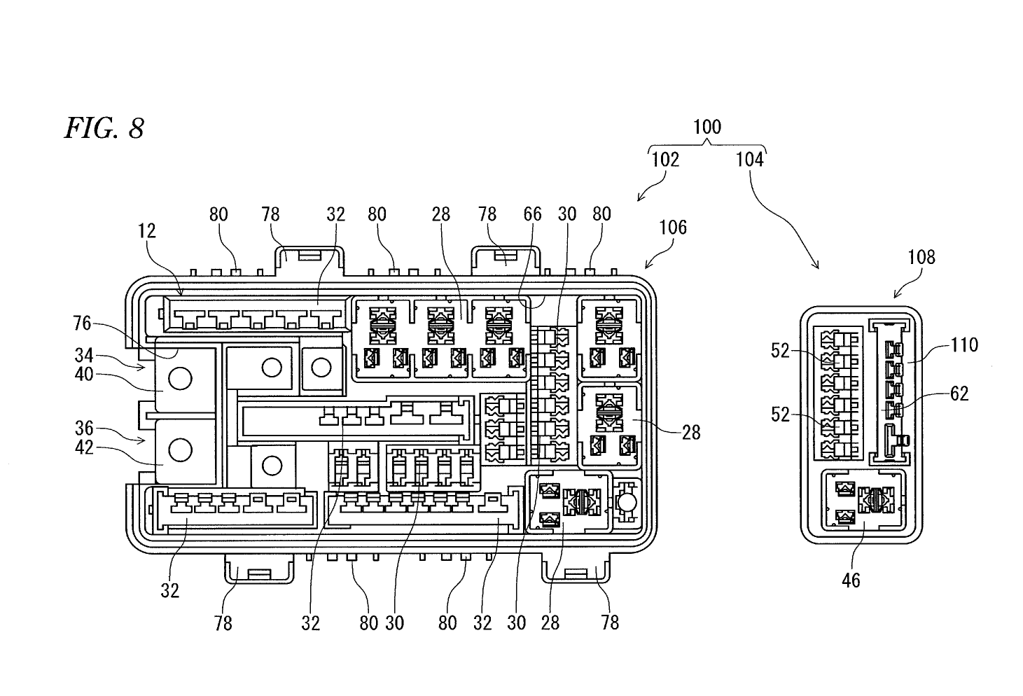

FIG. 8 shows the main portions of an electrical connection box 100 according to a third embodiment of the invention. The electrical connection box 100 is constituted of two box bodies, that is, a relay box 102 and an option box 104. The relay box 102 is structured such that only the base unit 12 is mounted on the case 106. On the other hand, the option box 104 is structured such that an option unit 110 is mounted on a case 108. The option unit 110 includes, as electric part mounting portions, a relay mounting portion 46, a fuse mounting portion 52 and a fusible link mounting portion 62. In this manner, of course, multiple kinds of electric part mounting portions can be formed in an option unit. Also, in this embodiment, since the base unit 12 and option unit 110 are formed separately from each other, the base unit 12 and option unit 110 can also be disposed dispersed in the different portions of the vehicle body.

Although the embodiments of the invention have been described heretofore specifically, the invention is not limited to the above specific description. For example, the electric part mounting portions to be formed in the base unit and option units are not limited to the units to which, as in the above embodiments, the relays, fuses and fusible links are connected but, for example, there may also be employed units which correspond to various electric parts such as connectors. Here, the base unit and option unit need not always include the electric part mounting portions on which electric parts such as a relay and a fuse are to be mounted. Also, the option unit may also include a circuit board such as a control circuit.

What is claimed is:

1. An electrical connection box comprising:
a base unit including a common circuit to be used in common to multiple vehicle models or grades;
multiple kinds of option units respectively including an addition circuit selectively usable according to vehicle models or grades and, wherein:
the common circuit of the base unit and the addition circuit of one of the option units cooperate together to form an electric circuit to be connected to a load provided on a vehicle body by combining the one of the option units with the base unit; and
the base unit and the one of the option unit are mounted on a case of synthetic resin prepared for every vehicle model or grade and are then fixed to the vehicle body.

2. An electrical connection box according to claim 1, wherein:
the base unit includes a first electric part mounting portion;
the one of the option units includes a second electric part mounting portion; and
the synthetic resin is a material having lower heat resistance than the box bodies of the base unit and the option units.
